(19) United States
(12) Patent Application Publication
(10) Pub. No.: US 2022/0101252 A1
(43) Pub. Date: Mar. 31, 2022

(54) CONTROL APPARATUS, NON-TRANSITORY COMPUTER READABLE MEDIUM, AND CONTROL METHOD

(71) Applicant: TOYOTA JIDOSHA KABUSHIKI KAISHA, Toyota-shi (JP)

(72) Inventors: Ai MIYATA, Okazaki-shi (JP); Yurika TANAKA, Yokosuka-shi (JP); Hideo HASEGAWA, Nagoya-shi (JP); Hiroyuki SUZUKI, Miyoshi-shi (JP); Katsuhiro OHARA, Nagoya-shi (JP); Tomoya MAKINO, Kariya-shi (JP)

(73) Assignee: TOYOTA JIDOSHA KABUSHIKI KAISHA, Toyota-shi (JP)

(21) Appl. No.: 17/487,745

(22) Filed: Sep. 28, 2021

(30) Foreign Application Priority Data
Sep. 30, 2020 (JP) 2020-166385

(51) Int. Cl. G06Q 10/08; G06Q 50/30

(52) U.S. Cl. CPC G06Q 10/0832; G06Q 50/30; G06Q 10/0833

(57) ABSTRACT

A control apparatus, communicably connected to a delivery apparatus and at least one sensor, includes a controller configured to receive sensor information from the sensor and identify an act of a user from the sensor information, determine whether the identified act includes an act during which the user is not able to receive a package, and control the delivery apparatus to have the package arrive at the user, in a case in which the identified act does not include the act during which the user is not able to receive the package.

### CROSS-REFERENCE TO RELATED APPLICATION

This application claims priority to Japanese Patent Application No. 2020-166385 (filed on Sep. 30, 2020), the entire contents of which are incorporated herein by reference.

### TECHNICAL FIELD

The present disclosure relates to a control apparatus, a program, and a control method.

### BACKGROUND

There is known a delivery system in which a point on a route towards a delivery destination for a recipient of a package who is away from the delivery destination, to which a flying vehicle can descend, is set as a reception point, and the flying vehicle delivers the package to the reception point (for example, Patent Literature [PTL] 1).

### CITATION LIST

### Patent Literature

PTL 1: JP 2018-097444 A

### SUMMARY

Even if a package recipient is at a reception point, e.g. at home, there are times when the package recipient is not able to receive the package. The above-described PTL 1 does not take such times into account.

It would be helpful to provide a control apparatus, a program, and a control method that can have a package arrive at a time when a user is able to receive the package.

A control apparatus according to an embodiment of the present disclosure is communicably connected to a delivery apparatus and at least one sensor, and includes a controller configured to:

receive sensor information from the sensor and identify an act of a user from the sensor information;

determine whether the identified act includes an act during which the user is not able to receive a package; and

control the delivery apparatus to have the package arrive at the user, in a case in which the identified act does not include the act during which the user is not able to receive the package.

A program according to an embodiment of the present disclosure is configured to cause a computer, as a control apparatus communicably connected to a delivery apparatus and at least one sensor, to execute operations, the operations including:

receiving sensor information from the sensor and identifying an act of a user from the sensor information;

determining whether the identified act includes an act during which the user is not able to receive a package; and

controlling the delivery apparatus to have the package arrive at the user, in a case in which the identified act does not include the act during which the user is not able to receive the package.

A control method according to an embodiment of the present disclosure is performed by a control apparatus communicably connected to a delivery apparatus and at least one sensor, the control method including:

receiving sensor information from the sensor and identifying an act of a user from the sensor information;

determining whether the identified act includes an act during which the user is not able to receive a package; and

controlling the delivery apparatus to have the package arrive at the user, in a case in which the identified act does not include the act during which the user is not able to receive the package.

According to a control apparatus, a program, and a control method according to an embodiment of the present disclosure, it is possible to have a package arrive at a time when a user is able to receive the package.

### BRIEF DESCRIPTION OF THE DRAWINGS

In the accompanying drawings:

FIG. 1 is a schematic diagram of an information processing system;

FIG. 2 is a block diagram illustrating a configuration of a control apparatus;

FIG. 3 is a block diagram illustrating a configuration of a delivery apparatus;

FIG. 4 is a block diagram illustrating a configuration of a user terminal;

FIG. 5 is a diagram illustrating a data structure of a receiving condition database (DB);

FIG. 6 is a drawing illustrating a receiving condition input screen displayed on the user terminal;

FIG. 7 is a drawing illustrating a permission input screen displayed on the user terminal; and

FIG. 8 is a flowchart illustrating operations of the control apparatus.

### DETAILED DESCRIPTION

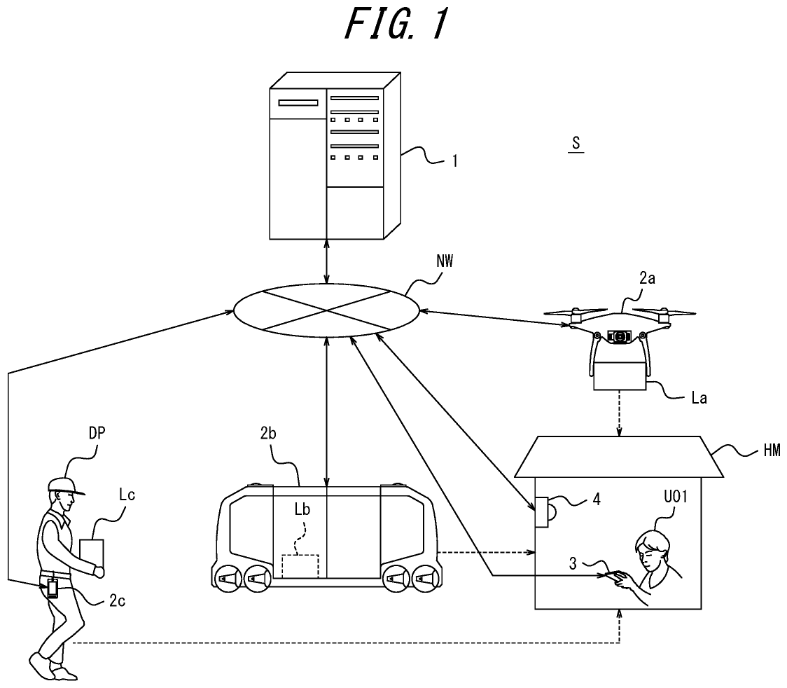

FIG. 1 is a schematic diagram of an information processing system S according to the present embodiment. The information processing system S includes a control apparatus 1, an unmanned aircraft 2a, a vehicle 2b, a delivery person terminal 2c, a user terminal 3, and a sensor 4, which are communicably connected to one another via a network NW. In the following description, for the sake of simplicity of explanation, the unmanned aircraft 2a, the vehicle 2b, and the delivery person terminal 2c are each referred to as a delivery apparatus 2. The unmanned aircraft 2a, the vehicle 2b, and the delivery person terminal 2c are respectively used to deliver a package La, a package Lb, and a package Lc to a home HM designated by a user U01. The network NW includes, for example, a mobile communication network and the Internet.

FIG. 1 illustrates one of each of the control apparatus 1 and the sensor 4 for convenience of explanation. However, the number of control apparatuses 1 and the number of sensors 4 are not limited to one. For example, processing performed by the control apparatus 1 according to the present embodiment may be performed by a plurality of control apparatuses 1 disposed in a distributed arrangement. A plurality of sensors 4 may be installed in one or more spaces in the home HM of the user U01 who operates the user terminal 3.

As illustrated in FIG. 1, in the present embodiment, the packages La, Lb, and Lc are delivered to the home HM of the user U01. As an alternative example, the packages La, Lb, and Lc may be delivered to a workplace, a storage space, or the like of the user U01.

An outline of processing executed by the control apparatus 1 according to the present embodiment will be described. The control apparatus 1 receives sensor information from the sensor 4 and identifies an act of the user U01 from the sensor information. The control apparatus 1 determines whether the identified act includes an act during which the user U01 is not able to receive a package. In a case in which the identified act does not include the act during which the user U01 is not able to receive a package, the control apparatus 1 controls the delivery apparatus 2 to have the package arrive at the user U01. According to this configuration, the control apparatus 1 can have a package arrive at a time when the user U01 is able to receive the package, thus supporting reliable delivery of the package.

The control apparatus 1 may be a server that assists a provider in providing a delivery service. The control apparatus 1 may be installed in, for example, a facility dedicated to the provider or a shared facility including a data center. The control apparatus 1 can control operations of the delivery apparatus 2. As an alternative example, the control apparatus 1 may be mounted on the delivery apparatus 2.

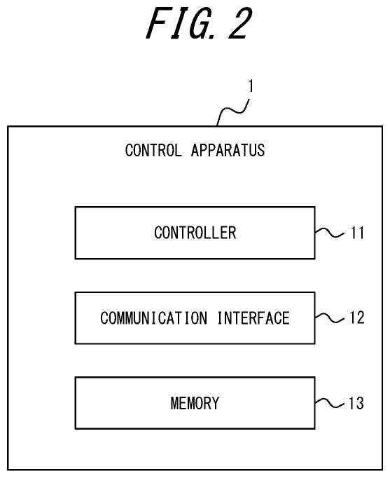

With reference to FIG. 2, an internal configuration of the control apparatus 1 will be described in detail.

The control apparatus 1 includes a controller 11, a communication interface 12, and a memory 13. The components of the control apparatus 1 are communicably connected to one another via a dedicated line, for example.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits, instead of the processors. Examples of the dedicated circuits may include a Field-Programmable Gate Array (FPGA) and an Application Specific Integrated Circuit (ASIC). The controller 11 may include an Electronic Control Unit (ECU).

The communication interface 12 includes a communication module conforming to one or more wired or wireless Local Area Network (LAN) standards for connection to the network NW. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network NW.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information regarding operations or control of the control apparatus 1. The memory 13 may store a system program, an application program, embedded software, and the like.

The memory 13 includes a receiving condition DB. Receiving conditions are conditions to be satisfied for a user to receive a package. As illustrated in FIG. 5, as an example, the receiving condition DB of the present embodiment may store, corresponding to a user ID, a time period, a day of the week, and an act (see “Others” in FIG. 5) during which a user is not able to receive a package. The time period is a period of time during which a user is able to receive a package. The day of the week is a day on which a user is able to receive a package. Details will be described below.

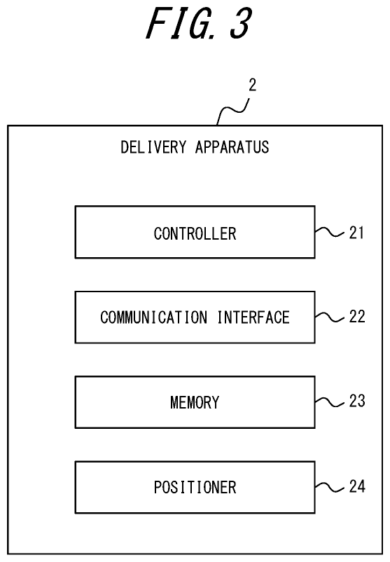

With reference to FIG. 3, an internal configuration of the delivery apparatus 2 will be described in detail.

The delivery apparatus 2 includes a controller 21, a communication interface 22, a memory 23, and a positioner 24. The components of the delivery apparatus 2 are communicably connected to one another via a dedicated line, for example.

Hardware components of the controller 21, the communication interface 22, and the memory 23 of the delivery apparatus 2 may be the same as hardware components of the controller 11, the communication interface 12, and the memory 13 of the control apparatus 1, respectively. The explanation here is omitted.

The positioner 24 includes at least one GNSS receiver. The term “GNSS” is an abbreviation of Global Navigation Satellite System. GNSS includes, for example, GPS, QZSS, BeiDou, GLONASS, and/or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positioner 24 measures the position of the delivery apparatus 2. A measurement result of the positioner 24 is acquired by the controller 21 as position information for the delivery apparatus 2. “Position information” is information that can identify the position of the delivery apparatus 2, and includes, for example, coordinates of the delivery apparatus 2.

As illustrated in FIG. 1, the delivery apparatus 2 may be the unmanned aircraft 2a, the vehicle 2b, or the delivery person terminal 2c.

The unmanned aircraft 2a is an aircraft without a person on board, and is also referred to as a drone or a multicopter. The unmanned aircraft 2a can be flown by remote control or autonomously. The unmanned aircraft 2a has a main body, propellers, and motors. As illustrated in FIG. 1, the unmanned aircraft 2a is provided with a package container for accommodating a package La therein. The unmanned aircraft 2a can move forward, move backward, turn, hover, and the like in the air according to increase or decrease in the number of rotations of the propellers by the motors. The main body includes the controller 21, the communication interface 22, the memory 23, and the positioner 24. The main body may also include a camera. The package container has a compartment space for accommodating a package La, and a lockable door. The package container may be provided with a plurality of compartment spaces so that packages La destined for a plurality of delivery destinations may be transported at the same time. The lockable door can be unlocked by the user U01, who is a recipient of the package La, by entering a passcode through an input interface of the unmanned aircraft 2a. The lockable door may be unlocked by the user U01 by displaying an unlocking code on the user terminal 3 and letting the camera of the unmanned aircraft 2a read the unlocking code. Instead of the package container, the unmanned aircraft 2a may be provided with arms configured to grasp a package La, while flying.

The vehicle 2b includes any type of vehicle, such as, for example, a micromobility device, a gasoline vehicle, a diesel vehicle, an HEV, a PHEV, a BEV, or an FCEV. The components of the vehicle 2b are communicably connected to one another via an on-board network such as a Controller Area Network (CAN), or a dedicated line, for example. As illustrated in FIG. 1, the vehicle 2b delivers a package Lb. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. Driving of the vehicle 2b may be automated at any level. The automation level is, for example, any one of Level 1 to Level 5 according to the level classification defined by SAE. The term “SAE” is an abbreviation of Society of Automotive

Engineers. The vehicle 2b may be a MaaS-dedicated vehicle. The term “MaaS” is an abbreviation of Mobility as a Service. As an alternative example, the vehicle 2b may be driven by a driver.

The delivery person terminal 2c is a terminal in the possession of a delivery person DP who delivers a package Lc. The delivery person terminal 2c is, for example, a mobile device such as a mobile phone, a smartphone, a wearable device, or a tablet. The delivery person terminal 2c may include a display. The display displays an address of a delivery destination, a delivery time, and the like for the package Lc. The delivery person DP sees the displayed contents and performs delivery.

The user terminal 3 is operated by the user U01 who is a recipient of a package. The terminal apparatus 30 is, for example, a mobile device such as a mobile phone, a smartphone, a wearable device, or a tablet, or a PC. The term “PC” is an abbreviation of personal computer.

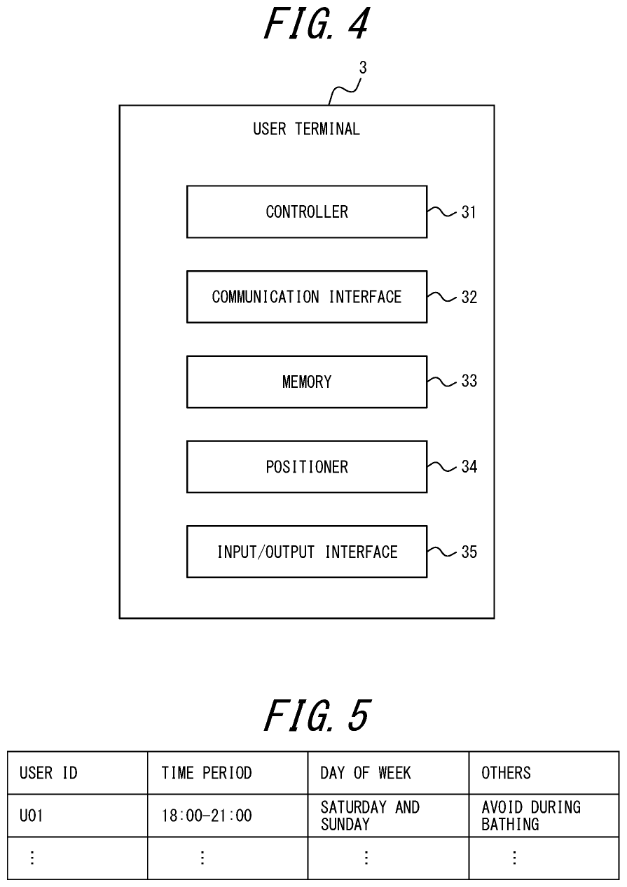

With reference to FIG. 4, an internal configuration of the user terminal 3 will be described in detail.

The user terminal 3 includes a controller 31, a communication interface 32, a memory 33, a positioner 34, and an input/output interface 35. The components of the user terminal 3 are communicably connected to one another, for example, via a dedicated line.

In the present embodiment, the hardware components of the controller 31, the communication interface 32, the memory 33, and the positioner 34 of the user terminal 3 may be the same as the hardware components of the controller 21, the communication interface 22, the memory 23, and the positioner 24 of the delivery apparatus 2, respectively. The explanation here is omitted.

The input/output interface 35 includes at least one interface for input. The interface for input is, for example, a physical key, a capacitive key, a pointing device, a touch screen integrally provided with a display, or a microphone. The input/output interface 35 receives an operation for inputting information for use in operations of the user terminal 3. The input/output interface 35, instead of being included in the user terminal 3, may be connected to the user terminal 3 as an external input device. As a connection method, any technology such as, for example, USB, HDMT® (HDMT is a registered trademark in Japan, other countries, or both), or Bluetooth® can be used. The term “USB” is an abbreviation of Universal Serial Bus. The term “HDMI®” is an abbreviation of High-Definition Multimedia Interface.

The input/output interface 35 further includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The input/output interface 35 outputs information resulting from operations of the user terminal 3. The input/output interface 35, instead of being included in the user terminal 3, may be connected to the user terminal 3 as an external output device. As a connection method, any technology such as, for example, USB, HDMI®, or Bluetooth® can be used.

The sensor 4 may be at least one of a motion sensor, an image sensor, a weight sensor, an illuminance sensor, a photosensor, a temperature sensor, a humidity sensor, a distance sensor, an ultrasonic sensor, a GPS sensor, a vibration sensor, or an air flow sensor.

As illustrated in FIG. 1, the sensor 4 is installed in the home HM of the user U01. One or more sensors 4 may be installed respectively in at least one of the following spaces in the home HM: bedroom, bathroom, lavatory, living room, entrance, kitchen, dining room, corridor, washroom, dressing room, shower room, closet, boxroom, attic, loft, closet, study, family room, boiler room, storage room, stairs, veranda, or terrace. The sensor 4 may be installed so that there are no blind spots.

The sensor 4 transmits detected information to the control apparatus 1 as sensor information. From the sensor information, the control apparatus 1 can identify the presence of a particular user, an act of a particular user, the number of people in the home HM, and the like.

Hereinafter, processing executed by the information processing system S according to the present embodiment will be described in detail. Here, as an example, a case is described in which the user U01 operating the user terminal 3 requests delivery of a purchased product using an application or other communication service.

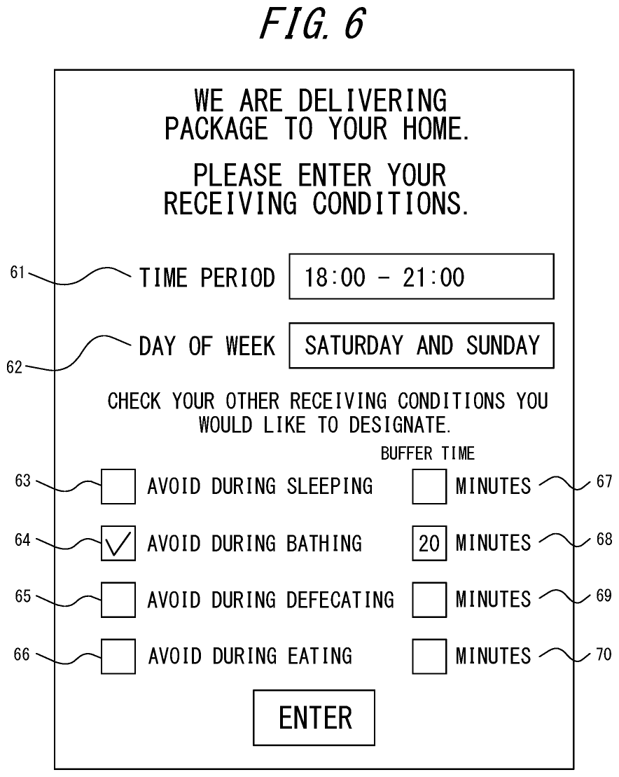

As illustrated in FIG. 6, the user U01 inputs receiving conditions for a package via the input/output interface 35. The input/output interface 35 displays a screen that prompts the user U01 to enter the receiving conditions. In the present embodiment, the receiving conditions include the following information, for example.

Condition 61: a time period in which delivery is to be made

Condition 62: a day of the week on which delivery is to be made

Condition 63: whether to avoid delivery during sleeping

Condition 64: whether to avoid delivery during bathing

Condition 65: whether to avoid delivery during defecating (i.e., during using lavatory)

Condition 66: whether to avoid delivery during eating

Condition 67: a buffer time after bedtime (i.e., after waking up) during which delivery should be avoided

Condition 68: a buffer time after bathing during which delivery should be avoided

Condition 69: a buffer time after defecating during which delivery should be avoided

Condition 70: a buffer time after eating during which delivery should be avoided

As indicated by the conditions 63 to 66, in the present embodiment, as an example, sleeping, bathing, defecating, and eating can be specified as predetermined acts during which the user U01 is not able to receive a package. Whether the user U01 is sleeping, bathing, defecating, eating can be determined using the sensors 4 (e.g., motion sensors, illuminance sensors, image sensors, or vibration sensors) installed in a bedroom, a bathroom, a lavatory, and a dining room, respectively. As an alternative example, whether the user U01 is sleeping can be determined using a weight sensor installed in a bed in a bedroom of the home HM. Whether the user U01 is bathing can be determined using a temperature sensor or a humidity sensor.

As indicated by the conditions 67 to 70, any value can be specified as a buffer time after completion of each of the acts in association with the acts during which the user U01 is not able to receive a package. In this case, the specified buffer time may be stored in the receiving condition DB. It can be set that, even if the acts during which the user U01 is not able to receive a package are completed, a package is not to be delivered to the home HM until the subsequent buffer time has elapsed.

As illustrated in FIG. 6, in the present embodiment the receiving conditions are, as an example, that the time period is between 18:00-21:00, the days of the week are Saturday and Sunday, and that delivery is to be avoided during bathing.

Additionally or alternatively, the receiving conditions may include a condition of whether delivery is to be avoided while a person other than the user U01 is at the home HM.

Upon detecting that input of the receiving conditions has been completed, the user terminal 3 transmits the receiving conditions to the control apparatus 1.

Upon receiving the receiving conditions, the control apparatus 1 reads the receiving conditions. The control apparatus 1 stores the receiving conditions in the receiving condition DB of the memory 13.

As an alternative example, instead of receiving the receiving conditions from the user terminal 3, the control apparatus 1 may set receiving conditions based on a receiving history of the user U01 for past deliveries. For example, the control apparatus 1 may set, as the receiving conditions, a time period and a day of the week when the user U01 has received a package in the past, a time period and a day of the week when the user U01 has most frequently received packages in the past, or a time period and a day of the week when the probability that the user U01 has received packages in the past is greater than a predetermined value. The control apparatus 1 may set receiving conditions based on a missed delivery history for past deliveries. For example, the control apparatus 1 may identify an act during which the user U01 has missed a delivery in the past from the sensor information, and set the identified act as an act during which the user U01 is not able to receive a package. The control apparatus 1 stores the set receiving conditions in the receiving condition DB.

The control apparatus 1 receives sensor information from the sensors 4 at any given time, periodically, or irregularly. The control apparatus 1 identifies the user's acts from the sensor information.

For the sake of simplicity, the following explanation assumes that conditions on a time period and a day of the week are satisfied among the receiving conditions. In a case in which the conditions on a time period and a day of the week are not satisfied, delivery of a package is not made.

The control apparatus 1 determines whether the identified act of the user U01 includes an act during which the user U01 is not able to receive a package. Here, the control apparatus 1 determines whether the user U01 is bathing.

In a case in which the control apparatus 1 determines that the identified act of the user U01 includes the act during which the user U01 is not able to receive a package, the control apparatus 1 receives the sensor information again. The control apparatus 1 again determines whether an act of the user U01 identified from the sensor information received again includes the act during which the user U01 is not able to receive a package.

In a case in which the control apparatus 1 determines that the identified act of the user U01 does not include the act during which the user U01 is not able to receive a package, the control apparatus 1 controls the delivery apparatus 2 to have the package arrive at the home HM of the user U01. In a case in which the delivery apparatus 2 is the unmanned aircraft 2a or the vehicle 2b, the unmanned aircraft 2a or the vehicle 2b delivers the package to the home HM by automatic operation control. In a case in which the delivery apparatus 2 is the delivery person terminal 2c, the delivery person terminal 2c displays at least an address of the home HM of the user U01 and a delivery time for the package, and has the delivery person DP deliver the package.

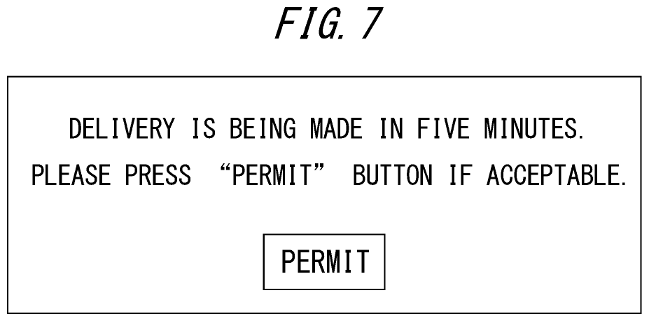

Additionally, in a case in which the control apparatus 1 determines that the identified act of the user U01 does not include the act during which the user U01 is not able to receive a package, the control apparatus 1 may calculate a time required until arrival of the package at the home HM. The required time may be calculated from at least one of the distance between a current position of the delivery apparatus 2 and the home HM, the average speed of the delivery apparatus 2, the weight of the package, or a wind direction. The control apparatus 1 may notify the user terminal 3 of the calculated required time. At the time of notification, the control apparatus 1 may transmit a screen as illustrated in FIG. 7 to the user terminal 3 to request a delivery permission. Upon receiving the delivery permission from the user terminal 3, the control apparatus 1 may control the delivery apparatus 2 to have the package arrive at the home HM.

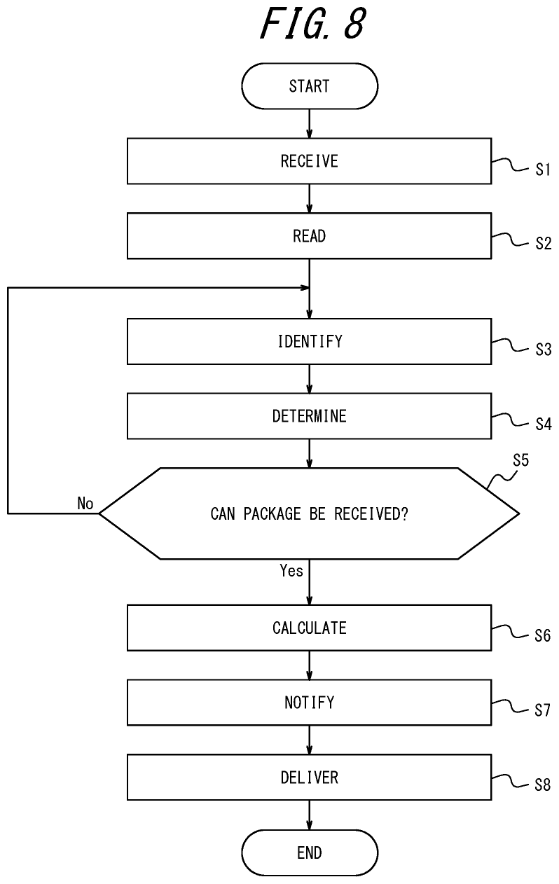

With reference to FIG. 8, a control method executed by the control apparatus 1 according to the present embodiment will be described.

In step S1, the control apparatus 1 receives, from the user terminal 3, information indicating receiving conditions for a package. The receiving conditions include an act during which the user U01 is not able to receive a package.

In step S2, the control apparatus 1 reads the received receiving conditions.

In step S3, the control apparatus 1 receives sensor information from the sensor 4, and identifies an act of the user U01 from the sensor information.

In step S4, the control apparatus 1 determines whether the identified act includes the act during which the user U01 is not able to receive a package.

In step S5, the control apparatus 1 determines whether the user U01 is able to receive a package, based on a determination result at step S4.

When step S5 is NO, the operation returns to step S3, and the control apparatus 1 executes step S3 and step S4 again.

When step S5 is YES, the control apparatus 1 calculates, in step S6, a time required for arrival of the package at the user U01. Step S6 is optional.

In step S7, the control apparatus 1 notifies the user terminal 3 of the calculated required time. Step S7 is optional.

In step S8, the control apparatus 1 makes delivery using the delivery apparatus 2. The control apparatus 1 has the package arrive at the user U01, in a case in which the identified act of the user U01 does not include the act during which the user U01 is not able to receive the package.

As described above, according to the present embodiment, the controller 11 of the control apparatus 1 receives sensor information from the sensor 4, and identifies an act of the user U01 from the sensor information.

The controller 11 determines whether the identified act includes an act during which the user U01 is not able to receive a package, and in a case in which the identified act does not include the act during which the user U01 is not able to receive a package, the controller 11 controls the delivery apparatus 2 to have the package arrive at the user U01. According to this configuration, the control apparatus 1 can have a package arrive at a time during which a user is able to receive the package, thus supporting reliable delivery of the package.

According to the present embodiment, the delivery apparatus 2 includes at least one of the unmanned aircraft 2a, the vehicle 2b, or the delivery person terminal 2c. According to this configuration, packages can be delivered in a variety of ways.

According to the present embodiment, in a case in which the identified act does not include the act during which the user U01 is not able to receive a package, the controller 11 determines whether a buffer time stored in association with the act has elapsed, and has the package arrive at the user U01 after a lapse of the buffer time. According to this configuration, the control apparatus 1 does not have a package arrive in a buffer time during which the user U01 is not ready to receive the package, even after the act during which the user U01 is not able to receive the package has been completed. Thus, the control apparatus 1 can support reliable delivery of packages.

According to the present embodiment, an act during which the user U01 is not able to receive a package includes at least one of sleeping, bathing, defecating, or eating. According to this configuration, various acts of the user U01 can be registered, thus further supporting reliable delivery of packages.

According to the present embodiment, the control apparatus 1 is communicably connected to a plurality of sensors. The plurality of sensors are installed in a plurality of spaces. According to this configuration, an act of the user U01 can be identified even if the user U01 is in any of a plurality of spaces.

According to the present embodiment, in a case in which the controller 11 determines that the identified act does not include the act during which the user U01 is not able to receive a package, the controller 11 calculates a time required for arrival of the package at the user U01, and notifies the user terminal 3 of the required time. According to this configuration, the control apparatus 1 can notify the user U01 of a soon to arrive package, thus reducing the possibility that the user U01 becomes unable to receive the package before arrival.

According to the present embodiment, the controller 11 has a package arrive at the user U01, in a case in which the controller 11 receives, after notifying the user terminal 3 of a required time, delivery permission from the user terminal 3. According to this configuration, the controller 11 can reduce the possibility that the user U01 is unaware of the notification and becomes unable to receive a package.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the above embodiment, a program that executes all or some of the functions or processing of the control apparatus 1 may be recorded on a computer readable recording medium. The computer readable recording medium includes a non-transitory computer readable medium and may be a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

The computer temporarily stores in a main memory, for example, a program recorded on a portable recording medium, or a program transferred from the server. Then, the computer reads the program stored in the main memory using a processor, and executes processes in accordance with the read program using the processor. The computer may read a program directly from the portable recording medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

1. A control apparatus communicably connected to a delivery apparatus and at least one sensor, the control apparatus comprising a controller configured to:
receive sensor information from the sensor and identify an act of a user from the sensor information;
determine whether the identified act includes an act during which the user is not able to receive a package; and
control the delivery apparatus to have the package arrive at the user, in a case in which the identified act does not include the act during which the user is not able to receive the package.

2. The control apparatus according to claim 1, wherein the delivery apparatus includes at least one of an unmanned aircraft, a vehicle, or a delivery person terminal.

3. The control apparatus according to claim 1, wherein in a case in which the identified act does not include the act during which the user is not able to receive the package, the controller is configured to determine whether a buffer time stored in association with the act has elapsed, and have the package arrive at the user after lapse of the buffer time.

4. A control apparatus according to claim 1, wherein the act during which the user is not able to receive the package includes at least one of sleeping, bathing, defecating, or eating.

5. The control apparatus according to claim 1, wherein
the at least one sensor is a plurality of sensors respectively installed in a plurality of spaces, and
the control apparatus is communicably connected to the plurality of sensors.

6. The control apparatus according to claim 1, wherein upon determining that the identified act does not include the act during which the user is not able to receive the package, the controller is configured to calculate a time required until arrival of the package at the user, and notify the user's user terminal of the required time.

7. The control apparatus according to claim 6, wherein in a case in which the controller has received delivery permission from the user terminal after notifying the user terminal of the required time, the controller has the package arrive at the user.

8. A delivery apparatus in which the control apparatus according to claim 1 is mounted.

9. A non-transitory computer readable medium storing a program configured to cause a computer, as a control apparatus communicably connected to a delivery apparatus and at least one sensor, to execute operations, the operations comprising:
receiving sensor information from the sensor and identifying an act of a user from the sensor information;
determining whether the identified act includes an act during which the user is not able to receive a package; and
controlling the delivery apparatus to have the package arrive at the user, in a case in which the identified act does not include the act during which the user is not able to receive the package.

10. The non-transitory computer readable medium according to claim 9, wherein the delivery apparatus includes at least one of an unmanned aircraft, a vehicle, or a delivery person terminal.

11. The non-transitory computer readable medium according to claim 9, wherein the operations further comprise, in a case in which the identified act does not include the act during which the user is not able to receive the package, determining whether a buffer time stored in association with the act has elapsed, and having the package arrive at the user after lapse of the buffer time.

12. The non-transitory computer readable medium according to claim 9, wherein the act during which the user is not able to receive the package includes at least one of sleeping, bathing, defecating, or eating.

13. The non-transitory computer readable medium according to claim 9, wherein
the at least one sensor is a plurality of sensors respectively installed in a plurality of spaces, and
the control apparatus is communicably connected to the plurality of sensors.

14. The non-transitory computer readable medium according to claim 9, wherein the operations further comprise, upon determining that the identified act does not include the act during which the user is not able to receive the package, calculating a time required until arrival of the package at the user, and notifying the user's user terminal of the required time.

15. A control method performed by a control apparatus communicably connected to a delivery apparatus and at least one sensor, the control method comprising:
receiving sensor information from the sensor and identifying an act of a user from the sensor information;
determining whether the identified act includes an act during which the user is not able to receive a package; and
controlling the delivery apparatus to have the package arrive at the user, in a case in which the identified act does not include the act during which the user is not able to receive the package.

16. The control method according to claim 15, wherein the delivery apparatus includes at least one of an unmanned aircraft, a vehicle, or a delivery person terminal.

17. The control method according to claim 15, further comprising, in a case in which the identified act does not include the act during which the user is not able to receive the package, determining whether a buffer time stored in association with the act has elapsed, and having the package arrive at the user after lapse of the buffer time.

18. The control method according to claim 15, wherein the act during which the user is not able to receive the package includes at least one of sleeping, bathing, defecating, or eating.

19. The control method according to claim 15, wherein
the at least one sensor is a plurality of sensors respectively installed in a plurality of spaces, and
the control apparatus is communicably connected to the plurality of sensors.

20. The control method according to claim 15, further comprising, upon determining that the identified act does not include the act during which the user is not able to receive the package, calculating a time required until arrival of the package at the user, and notifying the user's user terminal of the required time.
